(19) United States
(12) Patent Application Publication
(10) Pub. No.: US 2020/0092045 A1
(43) Pub. Date: Mar. 19, 2020

(54) Radio Node and Methods in a Wireless Communications Network

(71) Applicant: Telefonaktiebolaget LM Ericsson (publ), Stockholm (SE)

(72) Inventors: Min Wang, Luleå (SE); Jinhua Liu, Beijing (CN)

(21) Appl. No.: 16/304,885

(22) PCT Filed: Nov. 12, 2018
(86) PCT No.: PCT/SE2018/051151

§ 371 Date: Nov. 27, 2018

(30) Foreign Application Priority Data
Jan. 10, 2018 (CN) PCT/CN2018/072089

(51) Int. Cl. H04L 1/18; H04L 5/00

(52) U.S. Cl. CPC H04L 1/188; H04L 1/1887; H04L 5/001; H04L 5/0053; H04L 5/0098; H04L 1/1812

(57) ABSTRACT

A method performed by a radio node for handling a Hybrid Automatic Repeat Request (HARQ) process is provided.

The radio node obtains (402) an indication of an unfinished HARQ process at an occurrence of a switch. The switch is to be performed by a User Equipment, UE. The switch relates to any one out of: a switch from a first carrier to a second carrier, a switch from a first cell to a second cell, and a switch from a first bandwidth part to a second bandwidth part.

When it is determined that the unfinished HARQ process will not be continued after the switch, the radio node decides (406) to trigger any option out of:
Option 1: triggering Radio Link Control, RLC, retransmissions of Protocol Data Units, PDUs, corresponding to the unfinished HARQ process to be performed after the switch has occurred, and
Option 2: triggering proactively scheduled retransmissions on HARQ, corresponding to the unfinished HARQ process, to be performed before the switch occurs.

### BACKGROUND

In a typical wireless communication network, wireless devices, also known as wireless communication devices, mobile stations, stations (STA) and/or User Equipments (UE), communicate via a Local Area Network such as a WiFi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5th Generation (5G). A service area or cell area is a geographical area where radio coverage is provided by the radio network node. The radio network node communicates over an air interface operating on radio frequencies with the wireless device within range of the radio network node. The radio network node communicates to the wireless device in DownLink (DL) and from the wireless device in UpLink (UL).

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3rd Generation (3G) networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

NR Cell with Supplementary UL (SUL) Carrier

As the low carrier frequency bands were already deployed with 2G, 3G and 4G wireless communication systems, NR will be deployed at relatively higher frequencies. For wireless communication, the propagation loss will be roughly proportional to the square of the carrier frequency. Hence there may be a coverage issue for wireless communication over high carrier frequencies. For DL, the gNB may be equipped with powerful antenna systems and powerful amplifiers to boost the transmission power density, hence the DL coverage may be boosted. However, for UL, there are several restrictions such as transmit power, antenna size and cost of equipment. Hence there may be mismatch between UL and DL for a NR cell at high frequency.

For solving this, the NR introduced a SUL carrier for a NR cell, i.e. a NR cell has a SUL carrier plus a NR UL carrier. The SUL carrier is supposed to be a low frequency carrier which may be shared, in time and/or frequency domain, with other Radio Access Technology (RAT) systems such as LTE. FIG. 1 shows the coverages of a NR UL carrier 11 and the SUL carrier 12 in a NR cell provided by a gNB 10, with an NR frequency combination of paired carrier and SUL, for UL only. The cell further comprises an NR DL carrier 13.

It is desired that a SUL carrier is used when the NR UL carrier is of poor radio condition. While when the radio condition of NR UL carrier becomes good enough the NR UL carrier is used. Hence carrier switch may be frequently triggered.

Brief Introduction of Hybrid Automatic Repeat Request (HARQ) Operation in NR

In NR, asynchronous HARQ operation scheme is applied for both UL and DL. Asynchronous HARQ when used herein means two things, firstly, a radio node with asynchronous HARQ can select any HARQ process for transmission, second, there is no fixed timing relation between HARQ initial transmission and HARQ retransmission, meaning that a HARQ retransmission may occur at timing. After initial transmission of a transmission block such as a Transport Block (TB) with a HARQ process, the HARQ process is identified as pending state. A TB is the main data unit in LTE physical layer. A gNB or a UE may have transmitted the transmission block by means of its HARQ transmitter. A HARQ transmitter is an entity using a HARQ process when transmitting. A HARQ transmitter may maintain multiple parallel HARQ processes at the same time. A TB comprises a Medium Access Control (MAC) Protocol Data Unit (PDU), which comprises one or more MAC Service Data Unit (SDU)s. A HARQ process when used herein means a process, e.g., running in stop-and-wait mode. When a HARQ feedback Acknowledged (ACK) is received, it means the TB is successfully received by the receiver and the HARQ process is released to be idle, i.e. the HARQ process is ready to be used for new a data transmission with new TBs. Otherwise, when a HARQ feedback Not Acknowledged (NACK) is received, the HARQ process state is set to be in NACK state. In such case, retransmission shall be scheduled for the TB with the same HARQ process. There are also cases where the transmitter does not detect HARQ feedback after the transmission of the TB, then the HARQ process may be identified to be in Discontinuous transmission (DTX) state. In this case, a retransmission shall be scheduled. In this the difference is that the redundancy version should not be switched if the previous transmission of the TB is the initial transmission.

3GPP Progresses

In RAN2#99bis, the following agreements related to supplementary uplink were made.

Agreements for SUL Operation in Connected Mode:
1 When SUL is configured there are 2 ULs configured for one DL of the same cell.
2 At any point in time, each serving cell has at most one Physical Uplink Shared Channel (PUSCH) for transmission.

Clarification of Agreements:
1 In any slot, one PUSCH is used for transmission for a single serving cell (i.e. associated to a single DL). This excludes simultaneous transmission on 2 PUSCH within a single slot but does not restrict switching between the two PUSCH based on Layer 1 (L1)/Medium Access Control (MAC)/Radio Resource Control (RRC) signalling options.
2 RAN Layer 2 (RAN2) consider that it is up to RAN Layer 1 (RAN1) to decide where Physical Uplink Control Channel (PUCCH) is transmitted.
3 Option 2 is clarified to “RRC configures 2 UL. Signalling (e.g. Downlink Control Information (DCI) or MAC Control Element (CE)) is defined to enable UE to switch between the 2 different UL configurations, to use both ULs but not schedule them simultaneously based on agreement 1 above”
4 Final decision to use MAC CE signalling would be a RAN2 decision.
5 Final decision to use L1 signalling would be a RAN1 decision.
6 There is no RAN2 motivation to adopt DCI signalling.

Therefore the following agreement (the underlined line) made in RAN2#98 is still applicable to SULs.

Agreements:
1. RAN2 aims to keep Multi-bit HARQ feedback and Code Block Group (CBG)-based retransmission transparent to the MAC for one TB.
2. A single HARQ process supports one TB when the physical layer is not configured for downlink/uplink spatial multiplexing.
3. A single HARQ process supports one or multiple TBs when the physical layer is configured for downlink/uplink spatial multiplexing.
4. One HARQ entity should be supported in one carrier

According to the above agreements from RAN2#99bis, a serving cell configured with a SUL may e.g. have two possible types of configurations:
Configuration 1 (referred to as Option 1 in the agreement): The network uses full RRC Reconfiguration to select one of the two ULs for UL data transmission. The UE has only one UL to use at any time.
Configuration 2 (referred to as Option 2 in the agreement): The network configures both ULs. At any time, the network uses either L1 or L2 signalling to dynamically switch between two ULs for its PUSCH transmission.

In Configuration 1, the network uses RRC Reconfiguration to switch the UE between two ULs. The HARQ entity may be reconfigured as well assuming that the two carriers, the old carrier that the UE is using before the switch and the new carrier that the UE switches to, may have different numerologies, transmission durations or carrier bandwidth.

In Configuration 2, two ULs are configured and active at the same time, however, the UE uses only one of two ULs for data transmission at a time.

Some further agreements were made at RAN2#100,

Agreements:
1: HARQ process can continue when Bandwidth Part (BWP) and/or SUL switching occurs.
2: No impact to the spec to capture this understanding
3: For same cell, one common HARQ entity is used for both UL and SUL.

According to the existing RAN2 agreements, it has been decided that the UE maintains just one HARQ entity which is shared between two uplinks. The wording HARQ entity when used herein may mean the protocol entity that is responsible for the HARQ functionality.

Each UL may use different HARQ configurations, considering facts that each carrier may be configured with different numerologies, meaning that the HARQ entity must be reconfigured with the HARQ configuration suitable with the current serving carrier.

This may result in an unwanted delay.

### SUMMARY

An object of embodiments herein is to improve the performance of a wireless communications network using HARQ process.

According to a first aspect of embodiments herein, the object is achieved by a method performed by a radio node for handling a Hybrid Automatic Repeat Request, HARQ, process.

The radio node obtains an indication of an unfinished HARQ process at an occurrence of a switch. The switch is to be performed by a User Equipment, UE. The switch relates to any one out of: a switch from a first carrier to a second carrier, a switch from a first cell to a second cell, and a switch from a first bandwidth part to a second bandwidth part.

When it is determined that the unfinished HARQ process will not be continued after the switch, the radio node decides to trigger any option out of:
Option 1: triggering Radio Link Control, RLC, retransmissions of Protocol Data Units, PDUs, corresponding to the unfinished HARQ process to be performed after the switch has occurred, and
Option 2: triggering proactively scheduled retransmissions on HARQ, corresponding to the unfinished HARQ process, to be performed before the switch occurs.

According to a second aspect of embodiments herein, the object is achieved by a radio node for handling a Hybrid Automatic Repeat Request, HARQ, process. The radio node is configured to any one or more out of:
obtain an indication of an unfinished HARQ process at an occurrence of a switch e.g. from a first position to a second position, which switch is to be performed by a User Equipment, UE, and which switch is adapted to be related to any one out of: a switch from a first carrier to a second carrier, a switch from a first cell to a second cell, and a switch from a first bandwidth part to a second bandwidth part, and
when it is determined, that the unfinished HARQ process will not be continued after the switch, decide to trigger any option out of:

Option 1: triggering Radio Link Control, RLC, retransmissions of Protocol Data Units, PDUs, corresponding to the unfinished HARQ process to be performed after the switch has occurred, and

Option 2: triggering proactively scheduled retransmissions on HARQ, corresponding to the unfinished HARQ process, to be performed before the switch occurs.

Since the radio node determines if the transmissions of the unfinished HARQ processes shall be performed before (Option 2) or after (Option 1) the switch occurs, the negative impact from the HARQ operation interruption due to that the UE switches between the carriers, where the HARQ retransmissions cannot continue after the switch, is minimized, which results in an improved performance of a wireless communications network using HARQ process.

An advantage of embodiments herein is that a fast carrier switch may be performed without clear HARQ performance loss so that frequent fast carrier selection becomes applicable for frequency diversity gain due to e.g. radio quality change or channel availability change of uplink carriers, e.g. comprising unlicensed carrier and shared licensed carrier.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating prior art.

FIG. 3 is a schematic block diagram illustrating embodiments of a wireless communications network.

FIG. 4 is a flowchart depicting embodiments of a method in a radio node.

FIG. 5a, b are flowcharts depicting embodiments of a method.

FIG. 6 a, b are flowcharts depicting embodiments of a method.

FIG. 7 is a flowchart depicting embodiments of a method.

FIG. 8 is a schematic block diagram illustrating embodiments of a radio node.

FIG. 9 schematically illustrates a telecommunication network connected via an intermediate network to a host computer.

FIG. 10 is a generalized block diagram of a host computer communicating via a base station with a user equipment over a partially wireless connection.

FIGS. 11 to 14 are flowcharts illustrating methods implemented in a communication system including a host computer, a base station and a user equipment.

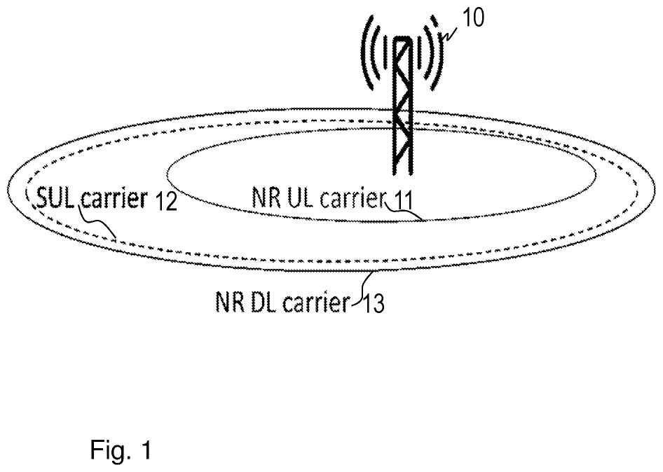

### DETAILED DESCRIPTION

As a part of developing embodiments herein a problem of the bitmap solution will first be identified and discussed.

When a carrier switch occurs, there may be some transport blocks which are not successfully received by the HARQ receiver yet. A HARQ receiver when used herein may e.g. mean an entity that performs the data reception via a HARQ process. The HARQ processes associated with these transport blocks are of either NACK or pending states. After the carrier switch, the UE MAC entity may not able to continue HARQ retransmissions on these unfinished processes on the new carrier in either of at least the following two cases:
Case 1: The new carrier may be configured with a different numerology, since it has agreed in 3GPP Rel-15 that the HARQ retransmissions across different numerologies are not allowed.
Case 2: the new carrier cannot provide a sufficient capacity due to narrower carrier bandwidth. For instance, when a UE switches from a NR UL carrier with a 200-MHz bandwidth to an SUL carrier of 20 MHz, it may occur that the SUL cannot provide enough resources such as e.g. bandwidth for HARQ retransmissions for some UEs. So those UEs have to wait longer timer to be scheduled.

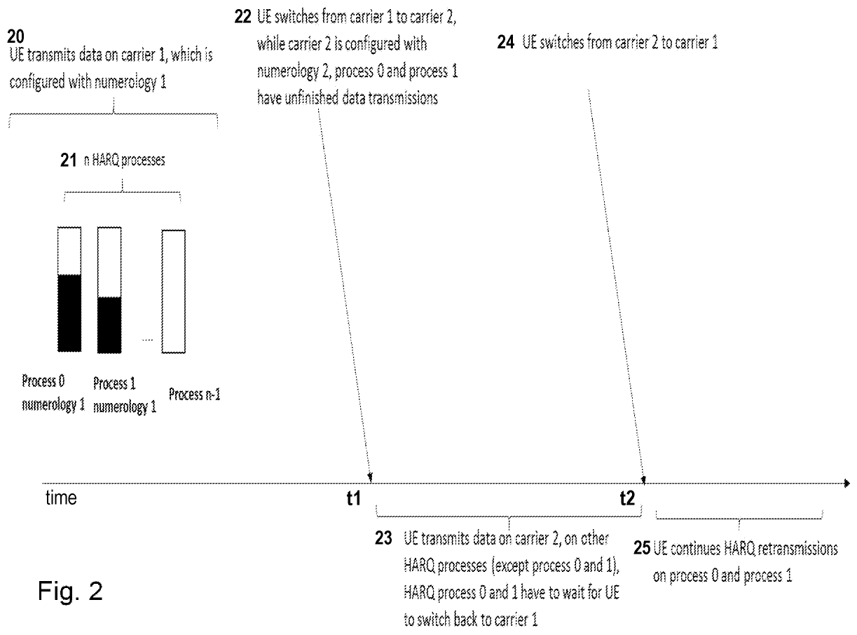

It may be expected that the HARQ operation can continue by switching back to the old carrier. However, it is not always feasible. For instance, when a UE switches from NR UL carrier to SUL carrier due to the radio quality of NR UL carrier becomes too bad to be used, one cannot expect that HARQ processing can be continued via switching back due to the interruption can be too long. An example of the issue is illustrated in FIG. 2 depicting the what happens along a time axis. During time period 20 the UE transmits data on carrier 1, which is configured with numerology 1. The UE comprises n HARQ processes 21, Process 0 using numerology 0, Process 1 using numerology 1, up to Process n−1 using numerology n−1. At time t1 the UE switches 22 from carrier 1 to carrier 2, while carrier 2 is configured with numerology 2, process 0 and process 1 have unfinished data transmissions. During time period 23 the UE transmits data on carrier 2, on other HARQ processes (except process 0 and 1), HARQ process 0 and 1 have to wait for the UE to switch back to carrier 1. At time t2 the UE switches 24 from carrier 2 to carrier 1. During time period 25 the UE continues HARQ retransmissions on process 0 and process 1.

The Carrier switch irrespective of these HARQ processes can cause Radio Link Control (RLC) retransmission. This may result in unacceptable delay. For delay critical services, such latency is not acceptable. Moreover, the carrier switch may be often triggered due to a high fading variation if NR UL carrier is at high frequency. The service interruption would be even more serious and a scheme to optimize the data transmission in such situation is addressed herein.

An object of embodiments herein is to improve the performance of a wireless communications network.

According to an example, for NR cell with SUL carrier, there may be more than one uplink carrier. A fast carrier switch may be needed due the channel variation of NR carrier at high frequency. A further object of embodiments herein is to improve HARQ operation at a carrier switch.

Example embodiments herein provide methods to minimize the negative impact from a HARQ operation interruption due to that the UE switches between the carriers, or BWPs where the HARQ retransmissions cannot continue after the switch. According to an example of embodiments herein, a radio node determines if the transmissions of the unfinished HARQ processes can be continued on the new carrier. If not, e.g. quick RLC retransmissions may be triggered for corresponding RLC PDUs of the unfinished HARQ processes or proactively scheduled HARQ retransmissions may be triggered for the unfinished HARQ processes in the old carrier before carrier switch. The radio node may be any one out of a network node which may be a gNB, and a UE.

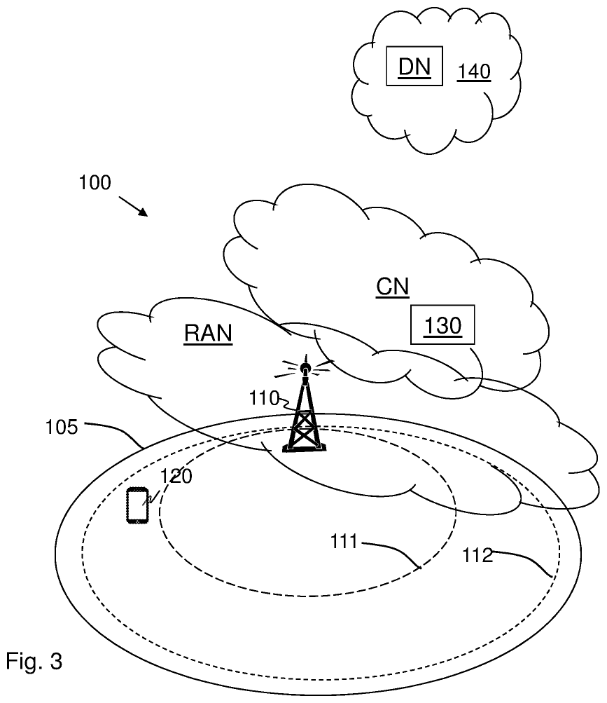

FIG. 3 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

Network nodes operate in the wireless communications network 100, such as a network node 110, providing radio coverage over a geographical area, a cell 105. The cell 105 may also be referred to as a service area, beam or a group of beams multiple TRPs, or multiple BWPs. The cell 105 may in some embodiments be configured with multiple UL carries such as multiple beams, multiple TRPs, or multiple BWPs. E.g. an NR cell configured with both a SUL carrier and an NR UL carrier. The cell 11 comprises at least a first UL carrier 111 and a second UL carrier 112, wherein the first carrier may be an NR UL carrier and the second UL carrier may be a SUL carrier. The SUL carrier may be associated with the NR UL carrier, i.e., the NR UL carrier may be the carrier that the SUL carrier provides extended UL coverage towards.

The network node 110 is a radio node and may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point or an Access Point Station (AP STA), an access controller, or any other network unit capable of communicating with a UE within the cell 11 served by the network node 110 depending e.g. on the radio access technology and terminology used. The network node 110 may be referred to as a serving radio network node and communicates with a UE 120 with Downlink (DL) transmissions to the UE 120 and Uplink (UL) transmissions from the UE 120.

Wireless devices such as e.g. a UE 120 operate in the wireless communications network 100. The UE120 is a radio node and may e.g. be an NR device a mobile station, a wireless terminal, an NB-IoT device, an eMTC device, a CAT-M device, a WiFi device, an LTE device and an a non-access point (non-AP) STA, a STA, that communicates via a base station such as e.g. the network node 110, one or more Access Networks (AN), e.g. RAN, to one or more core networks (CN). It should be understood by the skilled in the art that “UE” is a non-limiting term which means any terminal, wireless communication terminal, user equipment, Device to Device (D2D) terminal, or node e.g. smart phone, laptop, mobile phone, sensor, relay, mobile tablets or even a small base station communicating within a cell.

The methods according to embodiments herein are performed by a radio node which e.g. may be any one out of the network node 110 and the UE 120. The radio node is therefore referred to as the radio node 110, 120.

Further network nodes operate in the wireless communications network 100, such as a network node 130.

Methods according to embodiments herein may be performed by the radio node 110, 120. As an alternative, a Distributed Node DN and functionality, e.g. comprised in a cloud 140 as shown in FIG. 3 may be used for performing or partly performing the methods.

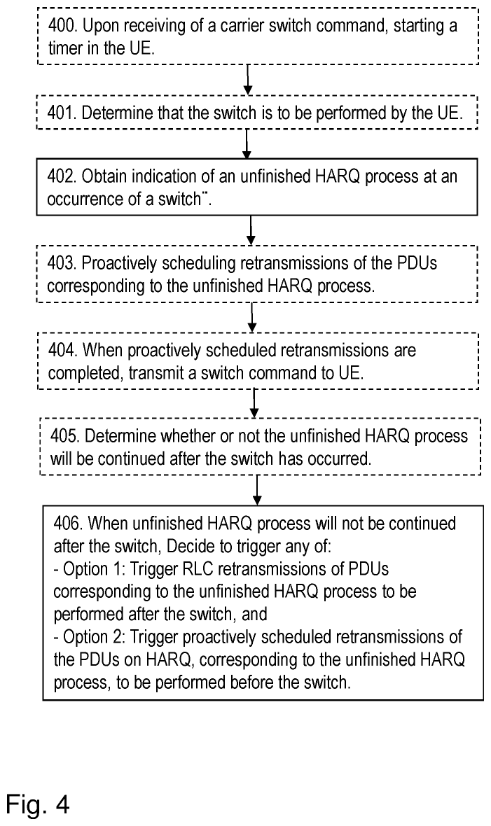

Example embodiments of a method performed by a radio node, 110, 120 for handling a HARQ process will now be described with reference to a flowchart depicted in FIG. 4. The radio node 110, 120 may e.g. be any one out of: a network node 110 gNodeB, gNB, and the UE 120. Some related first, second, third, fourth and fifth embodiments will be described more in detail later on in this document.

The method comprises the following actions, which actions may be taken in any suitable order. Actions that are optional are presented in dashed boxes in FIG. 4.

Action 400

According to some fourth embodiments, upon receiving of a carrier switch command, e.g. in action 404 below, starting 400 a timer such as an additional timer in the UE 120, and when the timer is expired, performing the deciding in action 406 below, of any one out of option 1 and option 2. The timer may e.g. be started when the UE 120 receives a carrier switch command, and stopped if the unfinished HARQ processes can continue the retransmissions, before the timer is expired. Thus, for these embodiments, both options, option 1 with RLC retransmission, and option 2 with proactively triggered retransmissions should be ignored if the timer does not expire. Since there is no issue to continue the HARQ retransmission on the new carrier, i.e., there is no interruption on the HARQ transmissions due to carrier switch. These fourth embodiments will be described more in detail below.

Action 401

According to some second embodiments relating to UL and DL and wherein option 2 is to be decided. According to an example scenario, it is realised e.g. due to poor radio conditions, that the UE 120 needs to switch to another carrier. Thus the radio node 110, 120 may determine that a switch is to be performed by the UE 120. As one option, the switch decision may be made by the network node 110 such as the gNB. As second option, the switch decision may be initiated by the UE 120, the UE 120 sends an indication or signalling to the network node 110, the network node 110 may decide if the UE's decision is accepted or not.

Action 402

This action relates to all embodiments. The radio node 110, 120 obtains, an indication of an unfinished HARQ process at an occurrence of a switch. The switch is to be performed by the UE 120. The switch relates to any one out of: a switch from a first carrier to a second carrier, a switch from a first cell to a second cell, and a switch from a first bandwidth part to a second bandwidth part.

Action 403

According to some of the second embodiments relating to UL and DL and wherein option 2 is to be decided. Upon determining, in action 401, that the switch is to be performed by the UE 120, the radio node 110, 120 proactively schedules retransmissions of the PDUs corresponding to the unfinished HARQ process.

The proactively scheduling of the retransmissions of the PDUs corresponding to the unfinished HARQ process may be performed according to any one out of:

When the HARQ process relates to DL transmissions, without waiting for HARQ feedback for the DL transmissions, and

when the HARQ process relates to UL transmissions, without Cyclic Redundancy Check, CRC, of results of the UL transmissions.

Action 404

According to some of the second embodiments relating to UL and DL and wherein option 2 is to be decided. When the proactively scheduled retransmissions of the PDUs on HARQ corresponding to the unfinished HARQ process are completed, the radio node 110, 120 may transmit a switch command to the UE 120 to perform the switch. This may be performed when the radio node is the network node 110.

Action 405

The radio node 110, 120 e.g. determines whether or not the unfinished HARQ process will be continued after the switch has occurred.

Action 406

The first part of this action relates to all embodiments. When it is determined, e.g. pre-determined, that the unfinished HARQ process will not be continued after the switch, the radio node 110, 120 decides to trigger any option out of:
Option 1: triggering Radio Link Control, RLC, retransmissions of Protocol Data Units, PDUs, corresponding to the unfinished HARQ process to be performed after the switch has occurred, and
Option 2: triggering proactively scheduled retransmissions on HARQ, corresponding to the unfinished HARQ process, to be performed before the switch occurs.

According to some first embodiments relating to DL and option 1 wherein the unfinished HARQ process relates to DL PDUs, the deciding 406 may comprise:
immediately after receiving a status report from the UE 120 related to the PDUs corresponding to the unfinished HARQ process,
triggering RLC retransmissions of PDUs corresponding to the unfinished HARQ process to be performed after the switch has occurred.

According to some first embodiments relating to UL and option 1 wherein the unfinished HARQ process relates to UpLink, UL, PDUs, the deciding 406 may comprise:

when receiving a status report in the UE 120 related to the PDUs corresponding to the unfinished HARQ process,

triggering RLC retransmissions of PDUs corresponding to the unfinished HARQ process after the switch has occurred.

Embodiments herein such as mentioned above will now be further described and exemplified. The text below is applicable to and may be combined with any suitable embodiment described above.

Embodiments herein may be applicable at least for any one or more of below scenarios:
LTE and/or NR UL Carrier switch, for a cell such as the cell 11 with multiple UL carriers, e.g. NR UL carrier such as the first UL carrier 111, and the SUL carrier such as the second UL carrier 112. E.g. a switch from the first UL carrier 111 to the second UL carrier 112.
LTE and/or NR Cell switch, wherein each cell has only one UL carrier and one DL carrier;
A NR BWP switch, wherein each BWP has separate HARQ process groups of single HARQ entity or respective HARQ entity; A BWP when used herein may e.g. mean a bandwidth part, serving two purposes: on one hand, it enables power savings at the UE since the UE doesn't need to monitor the full bandwidth for control channels (e.g., CORESET) all the time and on the other hand, it gives means for the network to manage an efficient radio resource management across the wide bandwidth via change of centre frequency.

An unfinished HARQ process whose status is NACK, Pending or DTX, i.e., no feedback has been detected by the HARQ transmitter.

### First Embodiments

In some embodiments, an RLC status report comprising Sequence Numbers (SNs) on the RLC PDUs that are not acknowledged yet may be triggered upon occurrence of a carrier, a BWP, or cell, only mentioned as carrier hereinafter, switch so that the RLC transmitter in the UE 120 or the network node 110 can retransmit those RLC PDUs on the new carrier as soon as the UE 120 switches to the new carrier. An RLC transmitter when used herein is an RLC protocol entity that takes care of the transmission of RLC PDUs. In this way, the RLC retransmission for those PDUs are performed immediately after carrier switch.

It should be noted that the option described in this embodiment may preferably be applied only to specific services and/or Logical Channels (LCHs). Those services and/or LCHs are latency critical.

It should further be noted that the option described in this embodiment may preferably be applied only when it is expected that the unfinished HARQ transmissions cannot be continued due to any reasons referred to as Case 1 and Case 2 above.

The procedures for triggered UL and DL carrier switches will be described separately.

DL Carrier Switch

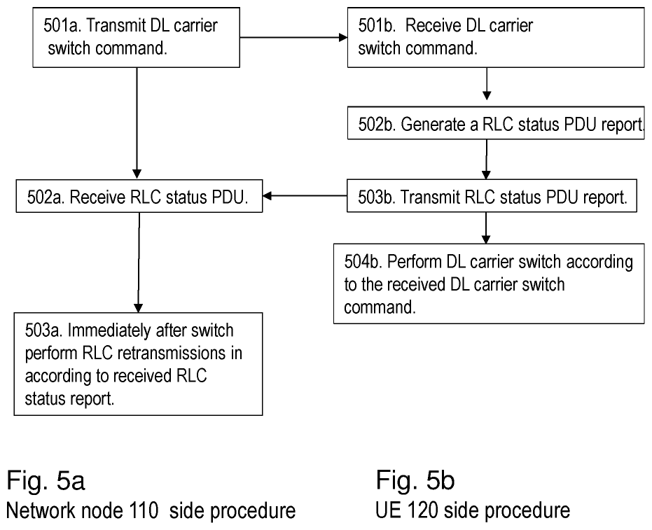

For DL carrier switch, where the UE 120 switches from one DL carrier to another DL carrier, it is the UE RLC entity in the UE 120 that may generate an RLC status report if there is any associated unfinished HARQ operation on the source carrier. The UE 120 may choose any UL carrier or an UL carrier determined by the network node 110 to transmit the RLC status report. FIG. 5a showing actions 501a-503a performed in the network node 110 and FIG. 5b showing actions 501b-504b performed in the UE 120 are flow charts example for DL carrier switch case.

The network node 110 transmits 501a DL carrier switch command which is received 501b by the UE 120. The UE 120 then generates 502b an RLC status report relating to retransmissions of the unfinished HARQ process. The RLC status PDU report is then transmitted 503b which is received 502a by the network node 110 as an indication of the retransmission of specific RLC PDUs, which are corresponding to unfinished HARQ process.

The UE 120 performs 504b DL carrier switch according to the received DL carrier switch command. The network node then immediately after the switch, performs 503a RLC retransmissions according to received RLC status report.

I.e. in this case the radio node in this example being the UE 120 decides 407 to use Option 1, to trigger retransmissions of PDUs corresponding to the unfinished HARQ process to be performed after the switch has occurred.

UL Carrier Switch

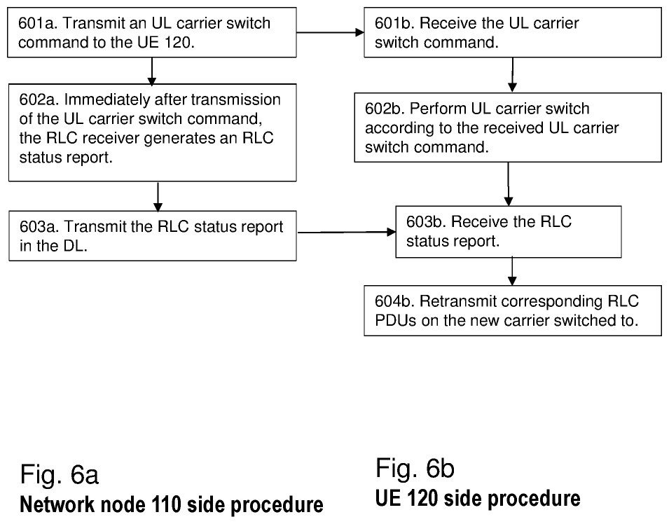

FIG. 6a showing actions 601a-603a performed in the network node 110 and FIG. 6b showing actions 601b-604b performed in the UE 120 are flowcharts for UL carrier switch case according to the first embodiment.

For UL carrier switch, it is the gNB RLC entity in the network node 110 that generates an RLC status report immediately after UL carrier switch if there is any unfinished associated HARQ transmissions on the source carrier, and send to the RLC transmitter at the UE 120 side. In this embodiment, the HARQ data on those unfinished HARQ processes in the source carrier can be cleared, when the UE MAC entity in the UE 120 starts to retransmit RLC PDUs on other HARQ processes on the new carrier.

The network node 110 transmits an UL carrier switch command 601a UL carrier switch command is received 601b by the UE 120.

Immediately after transmission of the UL carrier switch command, e.g. the RLC receiver in the network node 110 generates 602a an RLC status report. 602b. The UE 120 performs 602b UL carrier switch according to the received UL carrier switch command. The network node 110 transmits 603a the RLC status report in the DL which is received 603b by the UE 120. The UE 120 then retransmits 604b corresponding RLC PDUs on the new carrier switched to.

I.e., in this case the radio node in this example being the network node 110 decides 407 to use Option 1, to trigger retransmissions of PDUs corresponding to the unfinished HARQ process to be performed after the switch has occurred.

As another enhancement, the UE 120 or network node 110 such as their UE or gNB NB RLC entity may perform RLC retransmissions on the new carrier without any RLC acknowledgement whenever there is a carrier switch for a UE, where there are some unfinished HARQ transmissions on the old carrier.

As further enhancement, the retransmission of the data on the new carrier that are pending on the old carrier may be started by the Packet Data Convergence Protocol (PDCP) layer via a PDCP recovery like procedure. The retransmissions may be started without requiring any explicit acknowledgement from the receiver entity.

### Second Embodiments

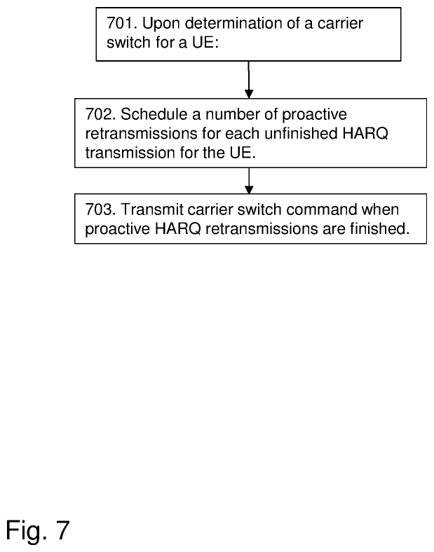

In some embodiments, upon determining to transmit a carrier switch signaling to the UE 120, the network node 110 may proactively schedule HARQ retransmissions for unfinished HARQ transmissions without waiting for HARQ feedback from the UE, DL HARQ, or Cyclic Redundancy Check (CRC) checking results, for UL HARQ, before the DL or UL carrier switch occurs. The redundancy version for scheduled HARQ retransmission may be the same as the initial HARQ transmission so that the data decoding may be performed even when the initial HARQ transmission is missed by the receiver node. This method may be an implementation scheme in the network node 110 side without change of specifications. FIG. 7 shows a flow chart of the procedure according to this second embodiment. Compared to the first embodiment, the solution according this embodiment may be implemented in the network node 110 side without specification change.

Upon determination 701 of a carrier switch for a UE such as the UE 120: The network node 110 schedules 702 a number of proactive retransmissions for each unfinished HARQ transmission for the UE 120. The network node 110 transmits 703 a carrier switch command when the proactive HARQ retransmissions are finished.

I.e., in this case the radio node in this example being the network node 110 decides 407 to use Option 2: Trigger proactively scheduled retransmissions on HARQ, corresponding to the unfinished HARQ process, to be performed before the switch.

### Third Embodiments

In some embodiments, the provided options are also applicable to other cases where the HARQ retransmissions of the unfinished HARQ processes cannot continue on the new carrier due to other reasons, for example, the HARQ configuration changes, such as transmission duration changes, or the bandwidth changes etc.

### Fourth Embodiments

In some embodiments, all the options may be ignored at least for some time if the UE 120 in a short while switches back to the old carrier, or switches to a new carrier, where the unfinished HARQ processes can continue the retransmissions. For instance the new carrier may be associated with the same numerology as the carrier where those unfinished HARQ processes were started. In this case, a timer such as an additional timer may be defined at the UE 120. This timer may be in additional to the two options as described above. The timer is set as a value considering the latency requirement of the corresponding services and/or LCHs. The proposed option can be applied as soon as the timer is expired. There may be two options to set the timer, i.e., the timer may be set per HARQ entity, or per HARQ process. The latter option gives better flexibility, since HARQ processes may be associated with different carriers or BWPs, and further associated with different numerologies, in this way, the timer may be better set considering the latency requirements of the services that are mapped with the specific numerologies. The value of the timer may be signaled to the UE 120 by the network node 110 together with the signaling informing about the carrier switch. The timer may be started when the UE 120 receives a carrier switch command, and stopped if the unfinished HARQ processes can continue the retransmissions, before the timer is expired.

Thus, for these embodiments, both options 1) RLC retransmission and 2) proactively triggered retransmissions should be ignored if the timer does not expire. Since there is no issue to continue the HARQ retransmission on the new carrier, i.e., there is no interruption on the HARQ transmissions due to carrier switch.

### Fifth Embodiments

It should be noted that in some embodiments, the HARQ retransmission across different numerologies may be allowed for specific HARQ processes. The network such as the network node 110 configures which HARQ processes are allowed to continue retransmissions regardless of the numerology. In this case, the UE 120 may perform retransmissions on the new carrier accordingly after the carrier switch. The configuration of whether the HARQ retransmissions across numerologies are allowed may be configured for specific services or LCHs.

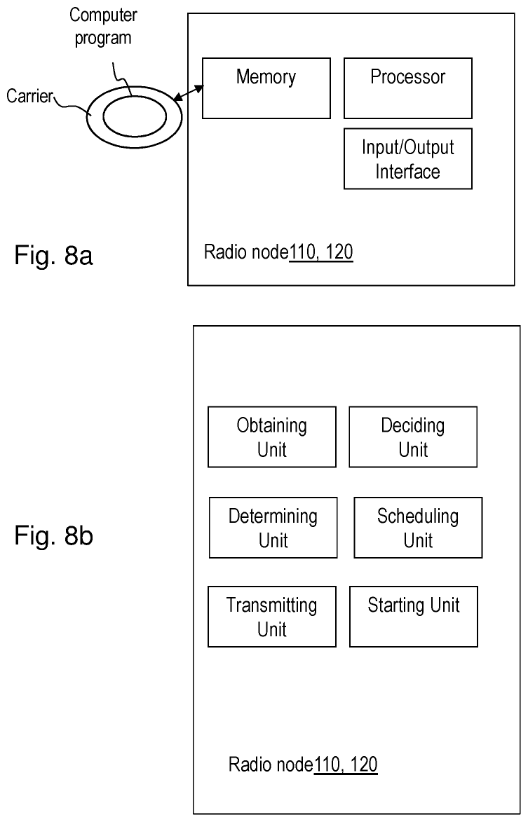

To perform the method actions e.g. for handling a HARQ, process, the radio node 110, 120 may comprise the arrangement depicted in FIGS. 8a and b. As mentioned above, the radio node 110, 120 may e.g. be any one out of: a network node 110 such as a gNodeB, gNB, and a User Equipment, UE, 120.

The radio node 110, 120 may comprise an input and output interface configured to communicate e.g. with the network node 110 if being a UE and with the UE 120 if being a network node. The input and output interface may comprise a wireless receiver (not shown) and a wireless transmitter not (shown).

The radio node 110, 120 is configured to, e.g. by means of an obtaining unit configured to, obtain an indication of an unfinished HARQ process at an occurrence of a switch e.g. from a first position to a second position. The switch is to be performed by the UE 120 and the switch is adapted to be related to any one out of: a switch from a first carrier to a second carrier, a switch from a first cell to a second cell, and a switch from a first bandwidth part to a second bandwidth part.

The radio node 110, 120 is further configured to, e.g. by means of a deciding unit configured to, when it is determined, e.g. pre-determined, that the unfinished HARQ process will not be continued after the switch, decide to trigger any option out of:
Option 1: triggering Radio Link Control, RLC, retransmissions of Protocol Data Units, PDUs, corresponding to the unfinished HARQ process to be performed after the switch has occurred, and
Option 2: triggering proactively scheduled retransmissions on HARQ, corresponding to the unfinished HARQ process, to be performed before the switch occurs.

The radio node 110, 120 may in some embodiments further be configured to, e.g. by means of a determining unit configured to, determine whether or not the unfinished HARQ process will be continued after the switch has occurred.

In some embodiments such as the first embodiment relating to option 1, wherein the unfinished HARQ process is adapted to relate to DL PDUs, the radio node, 110, 120 may further be configured to, e.g. by means of the deciding unit configured to, perform the decide to trigger by, immediately after receiving a status report from the UE 120 related to the PDUs corresponding to the unfinished HARQ process,—triggering RLC retransmissions of PDUs corresponding to the unfinished HARQ process to be performed after the switch has occurred.

In some embodiments such as the first embodiment relating to option 1, wherein the unfinished HARQ process relates to UL PDUs, the radio node, 110, 120 may further be configured to, e.g. by means of the deciding unit configured to, perform the decide to trigger by: when receiving a status report in the UE 120 related to the PDUs corresponding to the unfinished HARQ process,—triggering RLC retransmissions of PDUs corresponding to the unfinished HARQ process after the switch has occurred.

In some embodiments such as the second embodiment wherein option 2 is decided, the radio node, 110, 120 may further be configured to perform the deciding to trigger e.g. by means of the deciding unit, by:

upon determine that the switch is to be performed by the UE 120, e.g. by means of the determining unit, proactively schedule retransmissions of the PDUs corresponding to the unfinished HARQ process, e.g. by means of a scheduling unit,

and when the proactively scheduled retransmissions of the PDUs on HARQ corresponding to the unfinished HARQ process are completed, transmit a switch command to the UE 120 to perform the switch, e.g. by means of a transmitting unit.

The radio node, 110, 120 may further is configured to perform the proactively scheduling of the retransmissions of the PDUs corresponding to the unfinished HARQ process e.g. by means of a scheduling unit, according to any one out of:

when the HARQ process relates to DL transmissions, without waiting for HARQ feedback for the DL transmissions, and

when the HARQ process relates to UL transmissions, without Cyclic Redundancy Check, CRC, of results of the UL transmissions.

In some embodiments such as the fourth embodiment, the radio node, 110, 120 is further configured to perform the deciding to trigger e.g. by means of the deciding unit, by:

Upon receiving of a carrier switch command, e.g. by means of a starting unit, start a timer such as an additional timer in the UE 120, and when the timer is expired, perform the deciding e.g. by means of the deciding unit, of any one out of option 1 and option 2.

The radio node 110, 120 may e.g. comprise the obtaining unit, the deciding unit, the determining unit, the scheduling unit, the transmitting unit and the starting unit. Those skilled in the art will also appreciate that the units in the radio node 110, 120 mentioned above may refer to a combination of analog and digital circuits, and/or one or more processors configured with software and/or firmware, e.g. stored in the UE 120 that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

The embodiments herein may be implemented through a respective processor or one or more processors, such as a processor of a processing circuitry in the radio node 110, 120 depicted in FIG. 8, together with respective computer program code for performing the functions and actions of the embodiments herein. The program code mentioned above may also be provided as a computer program product, for instance in the form of a data carrier carrying computer program code for performing the embodiments herein when being loaded into the radio node 110, 120. One such carrier may be in the form of a CD ROM disc. It is however feasible with other data carriers such as a memory stick. The computer program code may furthermore be provided as pure program code on a server and downloaded to the radio node 110, 120.

The radio node 110, 120 may further comprise a memory comprising one or more memory units. The memory comprises instructions executable by the processor in.

The memory is arranged to be used to store e.g. HARQ related data, options, and applications to perform the methods herein when being executed in the radio node 110, 120.

In some embodiments, a respective computer program comprises instructions, which when executed by the respective at least one processor, cause the at least one processor of the radio node 110, 120 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

### FURTHER EXTENSIONS AND VARIATIONS

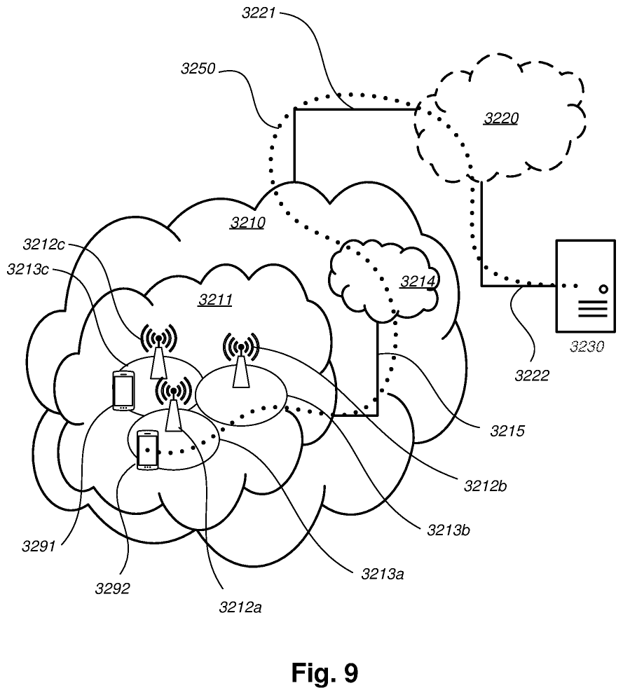

With reference to FIG. 9, in accordance with an embodiment, a communication system includes a telecommunication network 3210 such as the wireless communications network 100, e.g. a NR network, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

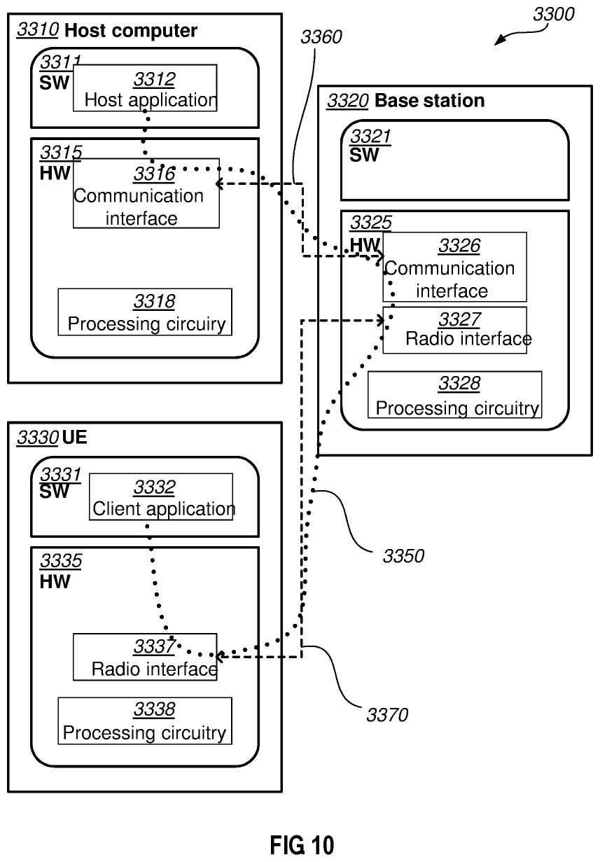

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

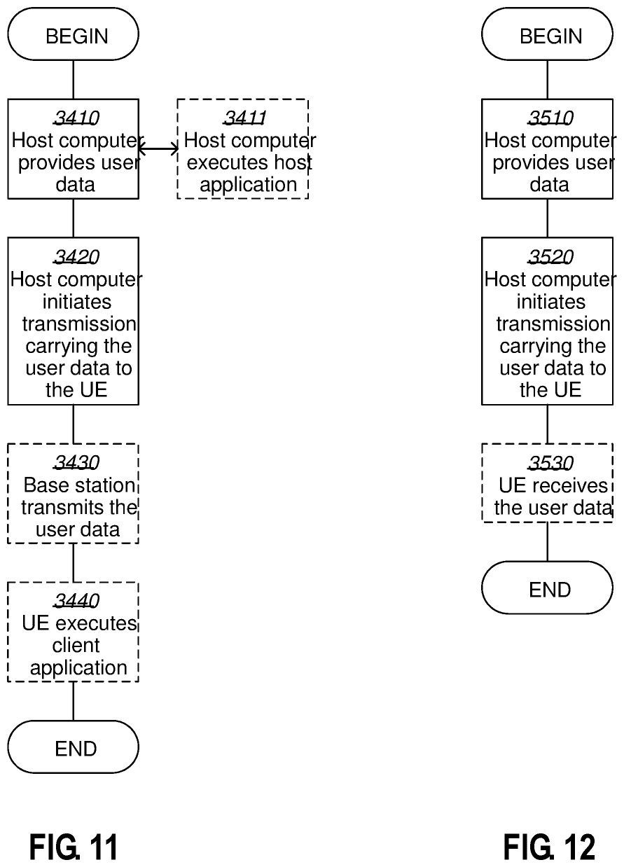

FIG. 11 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 11 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 12 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 12 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

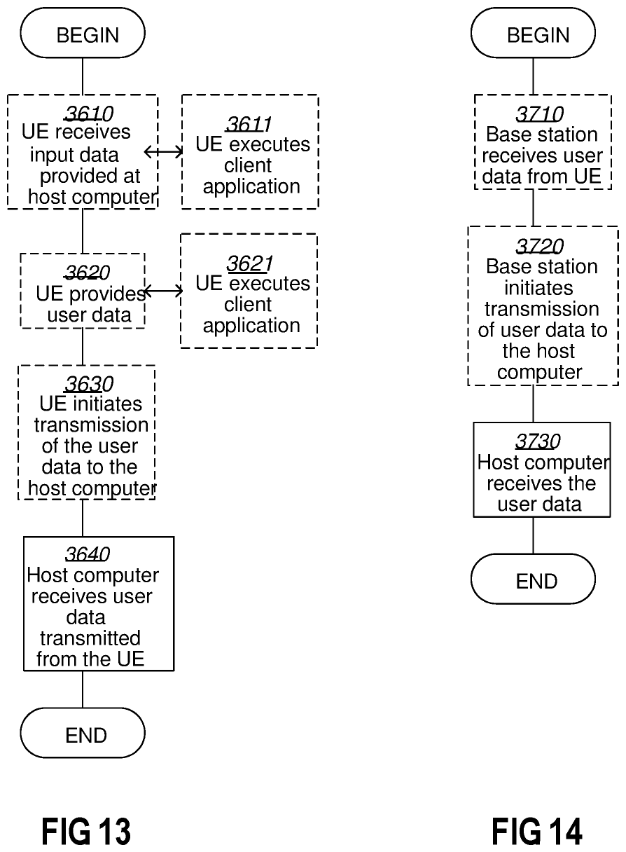

FIG. 13 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 13 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 14 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1-20. (canceled)

21. A method performed by a radio node, for handling a Hybrid Automatic Repeat Request (HARQ) process, the method comprising:
obtaining an indication of an unfinished HARQ process at an occurrence of a switch, which switch is to be performed by a User Equipment (UE) and which switch relates to any one out of a switch from a first carrier to a second carrier, a switch from a first cell to a second cell, and a switch from a first bandwidth part to a second bandwidth part; and
in response to determining that the unfinished HARQ process will not be continued after the switch, either:
triggering Radio Link Control (RLC) retransmissions of Protocol Data Units (PDUs) corresponding to the unfinished HARQ process to be performed after the switch has occurred, or
triggering proactively scheduled retransmissions on HARQ, corresponding to the unfinished HARQ process, to be performed before the switch occurs.

22. The method of claim 21, further comprising:
determining whether or not the unfinished HARQ process will be continued after the switch has occurred.

23. The method of claim 21, wherein the unfinished HARQ process relates to Downlink (DL) PDUs, the method comprising:
immediately after receiving a status report from the UE related to the PDUs corresponding to the unfinished HARQ process, triggering RLC retransmissions of PDUs corresponding to the unfinished HARQ process to be performed after the switch has occurred.

24. The method of claim 21, wherein the unfinished HARQ process relates to (UL) PDUs and wherein the method comprises:
responsive to receiving a status report in the UE related to the PDUs corresponding to the unfinished HARQ process, triggering RLC retransmissions of PDUs corresponding to the unfinished HARQ process after the switch has occurred.

25. The method of claim 21, the method comprising:
upon determining that the switch is to be performed by the UE, proactively scheduling retransmissions on HARQ corresponding to the unfinished HARQ process, and

26. The method of claim 25, the method further comprising:
after the proactively scheduled retransmissions on HARQ corresponding to the unfinished HARQ process are completed, transmitting a switch command to the UE to perform the switch.

27. The method of claim 25, wherein proactively scheduling retransmissions of the PDUs corresponding to the unfinished HARQ process is performed according to any one out of:
when the HARQ process relates to downlink transmissions, without waiting for HARQ feedback for the downlink transmissions, and
when the HARQ process relates to uplink transmissions, without Cyclic Redundancy Check (CRC) of results of the uplink transmissions.

28. The method of claim 21, the method comprising:
upon receiving of a carrier switch command, starting a timer; and
when the timer is expired, performing said triggering.

29. The method of claim 21, wherein the radio node is a network node or a User Equipment (UE).

30. A radio node, the radio node comprising:
receiver and transmitter circuitry; and
processing circuitry operatively coupled to the receiver and transmitter circuitry and configured to:
obtain an indication of an unfinished hybrid automatic repeat request (HARQ) process at an occurrence of a switch, which switch is to be performed by a User Equipment (UE) and which switch relates to any one out of a switch from a first carrier to a second carrier, a switch from a first cell to a second cell, and a switch from a first bandwidth part to a second bandwidth part; and
in response to determining that the unfinished HARQ process will not be continued after the switch, either:
trigger Radio Link Control (RLC) retransmissions of Protocol Data Units (PDUs) corresponding to the unfinished HARQ process to be performed after the switch has occurred, or
trigger proactively scheduled retransmissions on HARQ, corresponding to the unfinished HARQ process, to be performed before the switch occurs.

31. The radio node of claim 30, wherein the processing circuitry is further configured to:
determine whether or not the unfinished HARQ process will be continued after the switch has occurred.

32. The radio node of claim 30, wherein the unfinished HARQ relates to Downlink (DL) PDUs and wherein the processing circuitry is configured to, immediately after receiving a status report from the UE related to the PDUs corresponding to the unfinished HARQ process, trigger RLC retransmissions of PDUs corresponding to the unfinished HARQ process to be performed after the switch has occurred.

33. The radio node of claim 30, wherein the unfinished HARQ process relates to uplink (UL) PDUs, and wherein the processing circuitry is configured to:
responsive to receiving a status report in the UE related to the PDUs corresponding to the unfinished HARQ process, trigger RLC retransmissions of PDUs corresponding to the unfinished HARQ process after the switch has occurred.

34. The radio node of claim 30, wherein the processing circuitry is configured to, upon determining that the switch is to be performed by the UE, proactively schedule retransmissions on HARQ corresponding to the unfinished HARQ process.

35. The method of claim 34, wherein the processing circuitry is configured to transmit a switch command to the UE to perform the switch, after the proactively scheduled retransmissions on HARQ corresponding to the unfinished HARQ process are completed.

36. The radio node of claim 34, wherein the processing circuitry is configured to perform the proactively scheduling of the retransmissions of the PDUs corresponding to the unfinished HARQ process according to any one out of:
when the HARQ process relates to downlink transmissions, without waiting for HARQ feedback for the downlink transmissions, and
when the HARQ process relates to uplink transmissions, without Cyclic Redundancy Check (CRC) of results of the uplink transmissions.

37. The radio node of claim 30, wherein the processing circuitry is configured to:
upon receiving of a carrier switch command, start a timer such as an additional timer in the UE, and
when the timer is expired, perform said triggering.

38. The radio node of claim 30, wherein the radio node is a network node or a User Equipment (UE).

39. A non-transitory computer-readable medium comprising, stored thereupon, a computer program comprising instructions that, when executed by a processor of a radio node, causes the radio node to:
obtain an indication of an unfinished hybrid automatic repeat request (HARQ) process at an occurrence of a switch, which switch is to be performed by a User Equipment (UE) and which switch relates to any one out of a switch from a first carrier to a second carrier, a switch from a first cell to a second cell, and a switch from a first bandwidth part to a second bandwidth part; and
in response to determining that the unfinished HARQ process will not be continued after the switch, either:
trigger Radio Link Control (RLC) retransmissions of Protocol Data Units (PDUs) corresponding to the unfinished HARQ process to be performed after the switch has occurred, or
trigger proactively scheduled retransmissions on HARQ, corresponding to the unfinished HARQ process, to be performed before the switch occurs.
